(19) United States
(12) Patent Application Publication
(10) Pub. No.: US 2011/0280438 A1
(43) Pub. Date: Nov. 17, 2011

(54) IMAGE PROCESSING METHOD, INTEGRATED CIRCUIT FOR IMAGE PROCESSING AND IMAGE PROCESSING SYSTEM

(76) Inventor: Yong Zhang, Anhui Province (CN)

(21) Appl. No.: 12/747,518

(22) PCT Filed: May 14, 2010
(86) PCT No.: PCT/CN10/72777

§ 371 Date: Jun. 11, 2010

(51) Int. Cl. G06K 9/00

(52) U.S. Cl. 382/103

(57) ABSTRACT

An image processing method includes: identifying at least one moving object of a current image according to the current image and at least one image different from the current image; and utilizing a processing circuit to generate an adjusted current image by performing a first image adjustment operation upon the at least one moving object of the current image and performing a second image adjustment operation upon a surrounding region of the at least one moving object of the current image, where the first image adjustment operation is different from the second image adjustment operation.

### BACKGROUND OF THE INVENTION

1. Field of the Invention

The present invention relates to an image processing method, and more particularly, for an image processing method, which performs different image adjustment operations upon a moving object and a surrounding region of the moving object of an image, and associated integrated circuit and image processing system.

2. Description of the Related Art

TV or other video displayers generally have brightness and contrast ratio adjustment functions, to allow users to use these adjustment functions to control the brightness and the contrast ratio of video data displayed on a display apparatus. These brightness and contrast ratio adjustment functions, however, apply the same rule to all pixels of an image. For example, when a user adjusts the brightness of the TV to be lower, brightness of all the pixels of the image decrease with the same percentage. Therefore, for some video with low quality, the user cannot use these brightness and contrast ratio adjustment functions to effectively improve the quality of the video.

### BRIEF SUMMARY OF THE INVENTION

It is therefore an objective of the present invention to provide an image processing method, an associated integrated circuit and an image processing system, which performs different image adjustment operations upon a moving object and a surrounding region of the moving object of an image, to solve the above-mentioned problems.

According to one embodiment of the present invention, an image processing method comprises: identifying at least one moving object of a current image according to the current image and at least one image different from the current image; and utilizing a processing circuit to generate an adjusted current image by performing a first image adjustment operation upon the at least one moving object of the current image and performing a second image adjustment operation upon a surrounding region of the at least one moving object of the current image, where the first image adjustment operation is different from the second image adjustment operation.

According to another embodiment of the present invention, an integrated circuit for image processing comprises a moving object detector and a processing circuit. The moving object detector is utilized for identifying at least one moving object of a current image according to the current image and at least one image different from the current image. The processing circuit is utilized for generating an adjusted current image by performing a first image adjustment operation upon the at least one moving object of the current image and performing a second image adjustment operation upon a surrounding region of the at least one moving object of the current image, where the first image adjustment operation is different from the second image adjustment operation.

According to another embodiment of the present invention, an image processing system comprises a storage device, a moving object detector and a processing circuit. The storage device is utilized for storing a current image and at least one image different from the current image. The moving object detector is utilized for identifying at least one moving object of the current image according to the current image and the at least one image different from the current image. The processing circuit is utilized for generating an adjusted current image by performing a first image adjustment operation upon the at least one moving object of the current image and performing a second image adjustment operation upon a surrounding region of the at least one moving object of the current image, where the first image adjustment operation is different from the second image adjustment operation.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flowchart of an image processing method according to one embodiment of the present invention.

FIG. 2 shows a series of images.

FIG. 3 shows how to use motion vectors of macro-blocks to identify the moving object and the surrounding region of the image F3 shown in FIG. 2.

FIG. 4 is a diagram illustrating an integrated circuit according to one embodiment of the present invention.

FIG. 5 is a diagram illustrating an image processing system according to one embodiment of the present invention.

FIG. 6 is a flowchart of the image processing method according to one embodiment of the present invention.

### DETAILED DESCRIPTION OF THE INVENTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

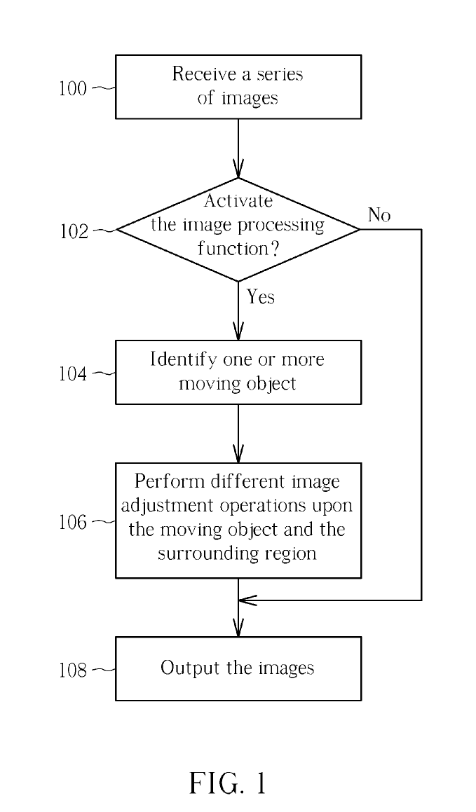

Please refer to FIG. 1. FIG. 1 is a flowchart of an image processing method according to one embodiment of the present invention. The image processing method can be applied to any video player and any video/image capturing machine such as a camera. Referring to FIG. 1, the flow is described as follows.

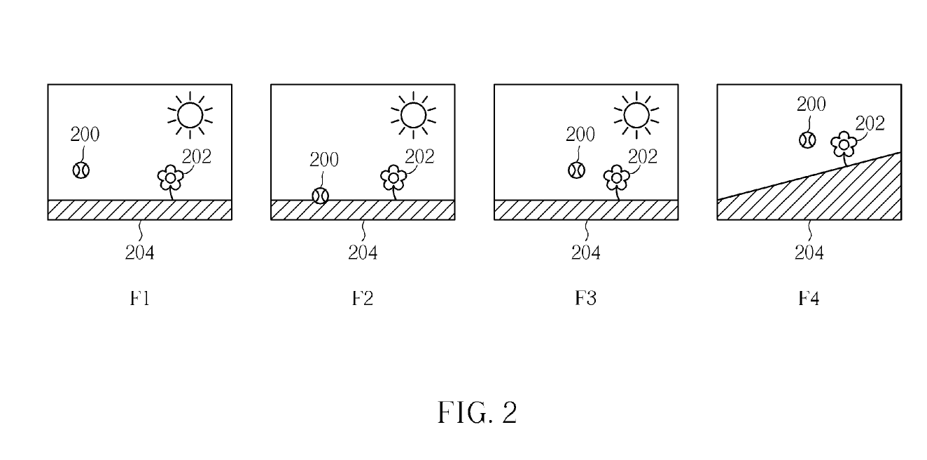

In Step 100, a series of images are received as shown in FIG. 2. Referring to FIG. 2, there are four successive images F1-F4, and each image includes at least a baseball 200, a flower 202 and a ground 204. It is noted that, the four successive images F1-F4 shown in FIG. 2 is for illustrative purposes only, and cannot be a limit of the present invention.

Then, in Step 102, it is determined if the image processing function of the present invention is activated. If the image processing function is not activated, the flow enters Step 108 to directly output the received images for further operations; if the image processing function is activated, the flow enters Step 104.

In Step 104, one or more moving objects of the images F1-F4 are identified. For example, as shown in FIG. 2, the baseball 200 should be identified as a moving object, and the flower 202 and the ground 204 should be determined as a surrounding region/background of the moving object.

Then, in Step 106, for one of the images F1-F4, the moving object and the surrounding region of the moving object of the image are performed different image adjustment operations. Taking the image F3 shown in FIG. 2 as an example, the baseball 200 (moving object) is performed a first image adjustment operation, and the surrounding region of the baseball 200 (including the flower 202, the ground 204, sky and the sun . . . ) is performed a second image adjustment operation different from the first image adjustment operation to generate a adjusted image F3′. Particularly, a contrast between the moving object and the surrounding region of the adjusted image F3′ is greater than a contrast between the moving object and the surrounding region when the moving object and the surrounding region both processed by the first image adjustment operation or the second image adjustment operation. Finally, in Step 108, the images or the adjusted images are outputted for further operations.

In addition, many methods can be used to identify the moving object(s) of the images F1-F4 in Step 104. For example, when the images frames F1-F4 are displayed on a computer, a user can use a mouse or other tools to select an area which serves as the background (the region except for the baseball 200) of the images F1-F4. That is, the unselected area serves as a moving object, and the selected area serves as the surrounding region of the moving object. Similarly, the user can also use the mouse or other tools to directly select the moving object (the baseball 200) of the images F1-F4.

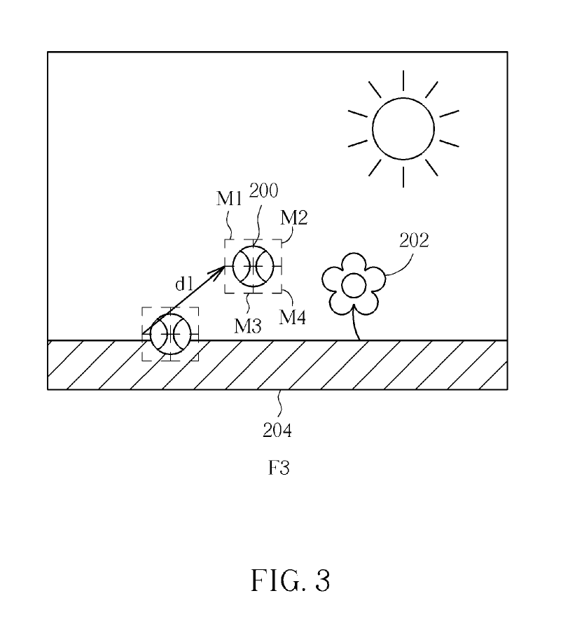

For another example, when the images frames F1-F4 are previously encoded by a standard such as MPEG (Moving Picture Experts Group) or H264, the moving object can be identified according to motion vectors of macro-block of the images, that is, when an absolute value of a motion vector of a macro-block between a current image and a previous image is greater than a threshold value, the macro-block is determined to belong to a moving object; and when an absolute value of a motion vector of a macro-block between a current image and a previous image is not greater than the threshold value, the macro-block is determined to belong to the surrounding region of the moving object. For example, please refer to FIG. 3 which shows how to use motion vectors of macro-blocks to identify the moving object and the surrounding region of the image F3 shown in FIG. 2. As shown in FIG. 3, the macro-block M1 has a motion vector d1, and an absolute value of the motion vector d1 can be used to determine whether the macro-block M1 belongs to a moving object or not. Referring to FIG. 3, pixels within the macro-blocks M1-M4 are identified as the moving object, and all pixels of the image F3 except for the pixels of the macro-blocks M1-M4 are identified as the surrounding region.

In some situations such as the images are captured while the camera is shaken or under a zoom in/zoom out operation, using the above-mentioned motion vectors to identify the moving object may have errors. For example, referring to the successive images F3 and F4, when the moving object is determines only by the motion vectors of the macro-blocks, all of the baseball 200, the flower 202 and the ground 204 will be identified as moving objects (In fact, however, the flower 202 and the ground 204 should be treated as a background rather than the moving objects). Therefore, to overcome this issue, in one embodiment of the present invention, when a motion vector of a macro-block between the current image and the previous image is greater than a threshold value, it is further to determine whether the macro-block is a background part of the current image or not; and when it is determined that the macro-block is not the background part of the current image, the macro-block is determined to belong to the moving object; and when it is determined that the macro-block is the background part of the current image, the macro-block is determined to belong to the surrounding region of the moving object.

In addition, in another embodiment, the moving object of a current image is identified according to the current image and a plurality of next images following the current image, and/or according to a plurality of previous images preceding the current image, and when a predetermined amount/percentage of the next images and/or the previous images shows a specific object within the next images and/or the previous images and the current image is moving, the specific object of the current image is identified as a moving object. For example, assuming that in successive one hundred images F1-F100, the images F1-F30 shows that a girl is dancing, the images F31-F50 shows that the girl stops dancing to stand still on a stage, and the images F51-F100 shows that the girl starts to dance again, then the girl in the images F31-F50 can also be identified as a moving object because the girl in the images F1-F30 and/or images F51-F100 is moving. In detail, taking image F40 as an example, the girl within the image F40 can be identified as a moving object according to a part of or all of the previous images such as F11-F39, or a part of or all of the next images such as F41-F70, or a part of or all of the images F11-F70, and when a predetermined amount (such as ten images) or a predetermined percentage (such as 20%) of the selected images (e.g., images F11-F70) shows that the girl within the selected images are a moving object, it is determined that the girl within the image F40 is also a moving object. In addition, regarding Step 106, there are many ways to perform different image adjustment operations upon the moving object and the surrounding region to enhance a contrast between the moving object and the surrounding region. For example, the brightness of the moving object can be adjusted by multiplying by a first parameter, and the brightness of the surrounding region can be adjusted by multiplying by a second parameter, where the first and the second parameters can be 1.2 and 1.1, respectively, or any other values to enhance the contrast between the moving object and the surrounding region. In another embodiment of the present invention, the chrominance or the color of the moving object and the surrounding region can be adjusted by different adjustment operations to enhance the contrast between the moving object and the surrounding region. Furthermore, if the images are black-and-white, the moving object can be adjusted to be colorful while the surrounding region is still black-and-white. In addition, the moving object can also be adjusted to have special effect such as flashing, blurring or sharpening . . . etc.

In addition, in another embodiment of the present invention, when a moving object of the current image becomes substantially static in the following images, the images are adjusted that the contrast between the moving object and the surrounding region is gradually decreased over time. For example, assuming that there are two hundreds successive images F1-F200, and the images F1-F30 shows a girl is dancing, and the images F31-F200 shows the girl stops dancing to stand still on the stage, then a contrast between the girl and its surrounding region are gradually decreased during the images F31-F200 are adjusted and displayed.

In addition, the above-mentioned image processing method can be applied to a camera. When a user intends to capture an image, the camera continuous captures images of a scene and performs the image adjustments as shown in FIG. 1 upon the images to generate adjusted images to be displayed on a display apparatus of the camera. Then, when a shutter of the camera is triggered, the camera stores the adjusted image into a removable storage device such as a memory card.

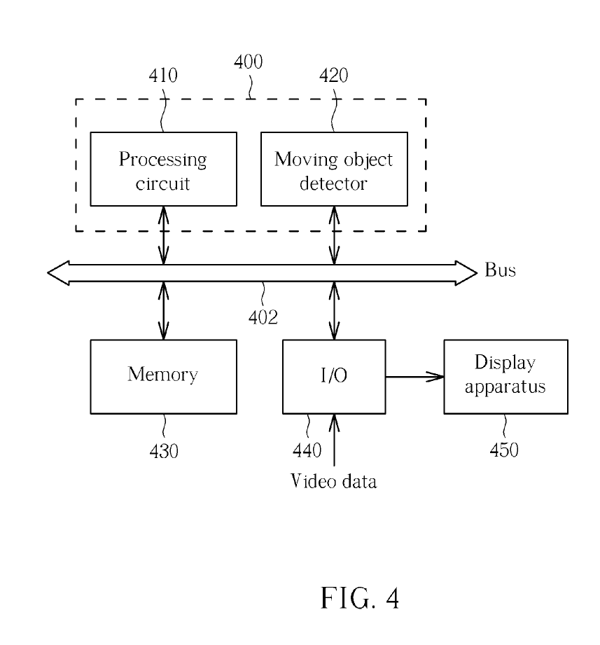

In addition, although the above-mentioned embodiments only shows a single moving object within the images, the person skilled in the art should apply the image processing method of the present invention to the images having more moving objects. Please refer to FIG. 4. FIG. 4 is a diagram illustrating an integrated circuit 400 according to one embodiment of the present invention. As shown in FIG. 4, the integrated circuit includes a processing circuit 410 and a moving object detector 420, where the integrated circuit 400 is coupled to a memory 430 and an I/O unit 440 via a bus. In the operations of the circuit shown in FIG. 4, the I/O unit 440 receives video data, and the video data is stored into the memory 430. Then, the processing circuit 410 and the moving object detector 420 performs the image processing operations shown in FIG. 1 upon the video data to generate adjusted video data. Then, the adjusted video data is outputted to a display apparatus 450 via the I/O unit 440.

In addition, the integrated circuit 400 shown in FIG. 4 is an example. In another embodiment of the present invention, the integrated circuit 400 can further include the memory 430 and the I/O unit 440, and this alternative design should fall within the scope of the present invention.

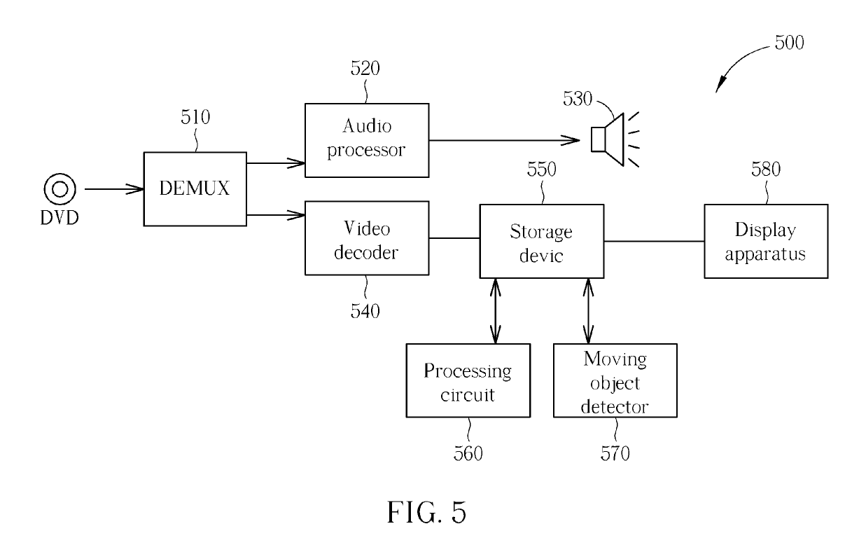

In addition, please refer to FIG. 5. FIG. 5 is a diagram illustrating an image processing system 500 according to one embodiment of the present invention. In this embodiment, the image processing system 500 is a DVD player, and includes a demultiplexer 510, an audio processor 520, a speaker 530, a video decoder 540, a storage device 550, a processing circuit 560, a moving object detector 570 and a display apparatus 580. In the operations of the image processing system 500, a data stream is divided into audio data and video data by the demultiplexer 510, and the audio data is processed by the audio processor and transmitted to the speaker 530. The video data is entered video decoder 540 for further operations.

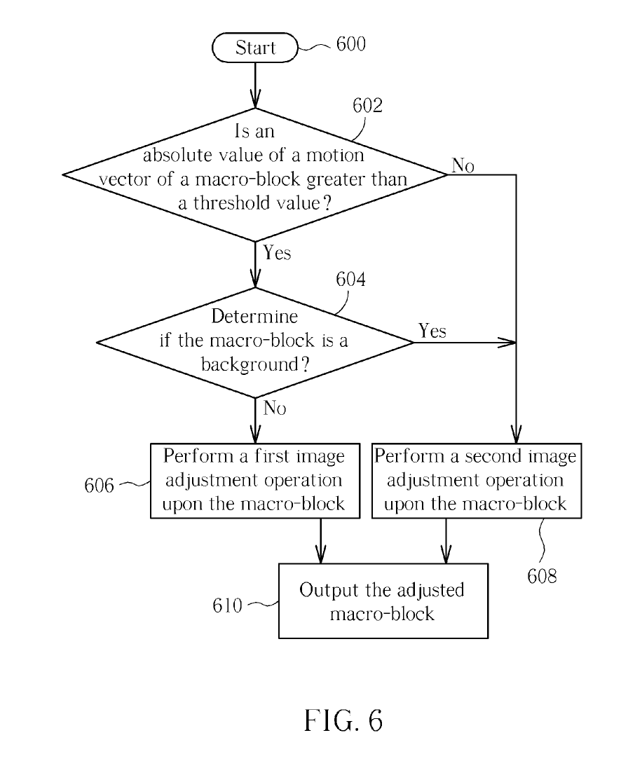

Please refer to FIG. 5 and FIG. 6 together. FIG. 6 is a flowchart of the image processing method according to one embodiment of the present invention. Referring to FIG. and FIG. 6, the flow is described as follows:

In Step 600, the flow starts, and the video decoder 540 decodes the video data to generate decoded video data and related information such motion vectors of macro-blocks of images, and the decoded video data and related information are stored into the storage device 550. In Step 602, for a macro-block of an image, it is to determine whether an absolute value of a motion vector of the macro-block is greater than a threshold value, if the absolute value of the motion vector is greater than the threshold value, the flow enters Step 604; and if the absolute value of the motion vector is not greater than the threshold value, the flow enters Step 608.

In Step 604, it is determined if the macro-block is a background of the image, and if the macro-block is a background of the image, the flow enters Step 608; and if the macro-block is not a background of the image, the flow enters Step 606.

In Step 606, the pixel data of macro-block is performed by a first image adjustment operation. In Step 608, the pixel data of macro-block is performed by a second image adjustment operation different from the first image adjustment operation. Finally, in Step 610, the image-adjusted macro-block generated in Step 606 or Step 608 is outputted to the display apparatus 580 or outputted for further operations.

Briefly summarized, in the image processing method of the present invention, a moving object and a surrounding region of the moving object of an image are performed different image adjustment operation to enhance a contrast between the moving object and the surrounding region. Therefore, the quality of the video can be effectively improved.

Those skilled in the art will readily observe that numerous modifications and alterations of the device and method may be made while retaining the teachings of the invention.

1. An image processing method, comprising:
identifying at least one moving object of a current image according to the current image and at least one image different from the current image; and
utilizing a processing circuit to generate an adjusted current image by performing a first image adjustment operation upon the at least one moving object of the current image and performing a second image adjustment operation upon a surrounding region of the at least one moving object of the current image, where the first image adjustment operation is different from the second image adjustment operation.

2. The image processing method of claim 1, wherein a contrast between the at least one moving object and the surrounding region of the adjusted current image is greater than a contrast between the at least one moving object and the surrounding region both processed by the first image adjustment operation or the second image adjustment operation.

3. The image processing method of claim 1, wherein the surrounding region of the at least one moving object of the current image includes all pixels of the current image except for pixels of the at least one moving object.

4. The image processing method of claim 1, wherein the step of identifying the at least one moving object comprises:
identifying the at least one moving object of the current image according to the current image and a plurality of next images following the current image;
wherein when a predetermined amount/percentage of the next images shows a specific object within the next images and the current image is moving, the specific object of the current image is identified as a moving object.

5. The image processing method of claim 1, wherein the step of identifying the at least one moving object comprises:
identifying the at least one moving object of the current image according to the current image and a plurality of previous images preceding the current image;
wherein when a predetermined amount/percentage of the previous images shows a specific object within the previous images and the current image is moving, the specific object of the current image is identified as a moving object.

6. The image processing method of claim 5, being employed in a camera and further comprising:
storing the adjusted current image into a removable storage device of the camera when a shutter of the camera is triggered.

7. The image processing method of claim 1, further comprising:
when a specific moving object of the at least one moving object becomes substantially static in a next image after the current image, performing a third image adjustment operation upon the specific moving object of the next image, and performing the second image adjustment operation upon a specific surrounding region of the specific moving object, where the third image adjustment operation is different from the first image adjustment operation and the second image adjustment operation;
wherein for the next image, a contrast between the specific moving object and the specific surrounding region is greater than a contrast between the specific moving object and the specific surrounding region both processed by the first image adjustment operation or the second image adjustment operation; and the contrast between the specific moving object and the specific surrounding region is less than a contrast between the specific moving object and the specific surrounding region respectively processed by the first image adjustment operation and the second image adjustment operation.

8. The image processing method of claim 1, wherein the at least one image is a previous image preceding the current image, and the step of identifying the at least one moving object comprises:
when a motion vector of a macro-block between the current image and the previous image is greater than a threshold value, determining that the macro-block belongs to the at least one moving object; and
when the motion vector of the macro-block is not greater than the threshold value, determining that the macro-block belongs to the surrounding region of the at least one moving object.

9. The image processing method of claim 1, wherein the at least one image is a previous image preceding the current image, and the step of identifying the at least one moving object comprises:
when a motion vector of a macro-block between the current image and the previous image is greater than a threshold value, determining if the macro-block is a background part of the current image;
when it is determined that the macro-block is not the background part of the current image, determining that the macro-block belongs to the at least one moving object;
when it is determined that the macro-block is the background part of the current image, determining that the macro-block belongs to the surrounding region of the at least one moving object; and
when the motion vector of the macro-block is not greater than the threshold value, determining that the macro-block belongs to the surrounding region of the at least one moving object.

10. An integrated circuit for image processing, comprising:
a moving object detector, for identifying at least one moving object of a current image according to the current image and at least one image different from the current image; and
a processing circuit, for generating an adjusted current image by performing a first image adjustment operation upon the at least one moving object of the current image and performing a second image adjustment operation upon a surrounding region of the at least one moving object of the current image, where the first image adjustment operation is different from the second image adjustment operation.

11. The integrated circuit of claim 10, wherein a contrast between the at least one moving object and the surrounding region of the adjusted current image is greater than a contrast between the at least one moving object and the surrounding region both processed by the first image adjustment operation or the second image adjustment operation.

12. The integrated circuit of claim 10, wherein the moving object detector identifies the at least one moving object of the current image according to the current image and a plurality of previous images preceding the current image; and
wherein when a predetermined amount/percentage of the previous images shows a specific object within the previous images and the current image is moving, the specific object of the current image is identified as a moving object.

13. The integrated circuit of claim 10, wherein when the moving object detector detects that a specific moving object of the at least one moving object becomes substantially static in a next image after the current image, the processing circuit performs a third image adjustment operation upon the specific moving object of the next image, and performing the second image adjustment operation upon a specific surrounding region of the specific moving object, where the third image adjustment operation is different from the first image adjustment operation and the second image adjustment operation;
wherein for the next image, a contrast between the specific moving object and the specific surrounding region is greater than a contrast between the specific moving object and the specific surrounding region both processed by the first image adjustment operation or the second image adjustment operation; and the contrast between the specific moving object and the specific surrounding region is less than a contrast between the specific moving object and the specific surrounding region respectively processed by the first image adjustment operation and the second image adjustment operation.

14. The integrated circuit of claim 10, wherein the at least one image is a previous image preceding the current image, and when a motion vector of a macro-block between the current image and the previous image is greater than a threshold value, the moving object detector determines that the macro-block belongs to the at least one moving object; and when the motion vector of the macro-block is not greater than the threshold value, the moving object detector determines that the macro-block belongs to the surrounding region of the at least one moving object.

15. The integrated circuit of claim 10, wherein the at least one image is a previous image preceding the current image, and when a motion vector of a macro-block between the current image and the previous image is greater than a threshold value, the moving object detector determines if the macro-block is a background part of the current image; when the moving object detector determines that the macro-block is not the background part of the current image, the moving object detector determines that the macro-block belongs to the at least one moving object; when the moving object detector determines that the macro-block is the background part of the current image, the moving object detector determines that the macro-block belongs to the surrounding region of the at least one moving object; and when the motion vector of the macro-block is not greater than the threshold value, the moving object detector determines that the macro-block belongs to the surrounding region of the at least one moving object.

16. An image processing system, comprising:
a storage device, for storing a current image and at least one image different from the current image;
a moving object detector, for identifying at least one moving object of the current image according to the current image and the at least one image different from the current image; and
a processing circuit, for generating an adjusted current image by performing a first image adjustment operation upon the at least one moving object of the current image and performing a second image adjustment operation upon a surrounding region of the at least one moving object of the current image, where the first image adjustment operation is different from the second image adjustment operation.

17. The image processing system of claim 16, wherein a contrast between the at least one moving object and the surrounding region of the adjusted current image is greater than a contrast between the at least one moving object and the surrounding region both processed by the first image adjustment operation or the second image adjustment operation.

18. The image processing system of claim 16, wherein the moving object detector identifies the at least one moving object of the current image according to the current image and a plurality of previous images preceding the current image; and
wherein when a predetermined amount/percentage of the previous images shows a specific object within the previous images and the current image is moving, the specific object of the current image is identified as a moving object.

19. The image processing system of claim 16, wherein the at least one image is a previous image preceding the current image, and when a motion vector of a macro-block between the current image and the previous image is greater than a threshold value, the moving object detector determines that the macro-block belongs to the at least one moving object; and when the motion vector of the macro-block is not greater than the threshold value, the moving object detector determines that the macro-block belongs to the surrounding region of the at least one moving object.

20. The image processing system of claim 16, wherein the at least one image is a previous image preceding the current image, and when a motion vector of a macro-block between the current image and the previous image is greater than a threshold value, the moving object detector determines if the macro-block is a background part of the current image; when the moving object detector determines that the macro-block is not the background part of the current image, the moving object detector determines that the macro-block belongs to the at least one moving object; when the moving object detector determines that the macro-block is the background part of the current image, the moving object detector determines that the macro-block belongs to the surrounding region of the at least one moving object; and when the motion vector of the macro-block is not greater than the threshold value, the moving object detector determines that the macro-block belongs to the surrounding region of the at least one moving object.
